(19) United States
(12) Patent Application Publication
(10) Pub. No.: US 2014/0071265 A1
(43) Pub. Date: Mar. 13, 2014

(54) ENDOSCOPE

(71) Applicant: Olympus Corporation, Tokyo (JP)

(72) Inventor: Kazuhiro Kanzaki, Tokyo (JP)

(73) Assignee: Olympus Corporation, Tokyo (JP)

(21) Appl. No.: 14/083,878

(22) Filed: Nov. 19, 2013

Related U.S. Application Data
(63) Continuation of application No. PCT/JP2011/061645, filed on May 20, 2011.

(51) Int. Cl. G02B 23/24; H04N 7/18

(52) U.S. Cl. CPC G02B 23/2476; H04N 7/183
USPC 348/82

(57) ABSTRACT

This endoscope is provided with: a main housing unit that is formed from a material having a surface resistance of 1 GΩ or less; a display unit that is mounted on one surface of the external surfaces of the main housing unit and displays images of an observation subject; an operating input portion that is mounted on the one surface of the main housing unit; and a sun-blocking shade that is fixed to the one surface of the main housing unit and protrudes from the one surface in a direction that intersects the one surface so as to surround a portion of the periphery of the display unit, and that is formed from a flexible resin whose surface resistance is 1 GΩ or less, and is characterized by the fact that the entire display unit and operating input portion are located within a space that is defined by the main housing unit and the shade.

### BACKGROUND OF THE INVENTION

1. Field of the Invention

The present invention relates to an endoscope. The present application is a Continuation Application of PCT Patent Application No. PCT/JP2011/061645, filed May 20, 2011, the contents of which are incorporated herein by reference.

2. Technical Background

Conventionally, an endoscope is used in order to observe the internal structure of an observation subject. An endoscope is provided with an elongated insertion portion that has an image acquisition portion at a distal end thereof and is inserted into the interior of an observation subject, and with a main unit to which a proximal end of the insertion portion is fixed. Images acquired by the image acquisition portion can be viewed by an observer. For example, in some cases, industrial endoscopes are used in regions where inflammable gas or dust that makes it difficult for an observer to directly view the observation subject is present.

In the main unit of the endoscope there is provided an operating input portion that performs operational inputs in order, for example, to cause the distal end portion of the insertion portion to be bent and to cause images to be acquired by the image acquisition portion. The operating input portion has a switch structure such as a lever and a push-button or the like, and an operational input can be made by moving the lever and the push-button.

The lever and the push-button have precise mechanisms such as contact points or links and there is, therefore, a possibility that such mechanisms will be damaged if they receive an external shock. Because of this, endoscopes have been proposed that have a structure that makes it possible to prevent levers and the like that are provided in the operating input portion from becoming damaged.

For example, an endoscope in which a substantially U-shaped guard that protects a bending lever that is used to make the insertion portion perform a bending operation is provided is described in Japanese Unexamined Patent Application, First Publication (JP-A) No. 2004-81797.

### SUMMARY OF THE INVENTION

The first aspect of present invention is an endoscope provided with: a main housing unit that is formed from a material having a surface resistance of 1 GΩ or less; a display unit that is mounted on one surface of the external surfaces of the main housing unit and displays images of an observation subject; an operating input portion that is mounted on the one surface of the main housing unit; and a sun-blocking shade that is fixed to the one surface of the main housing unit and protrudes from the one surface in a direction that intersects the one surface so as to surround a portion of the periphery of the display unit, and that is formed from a flexible resin whose surface resistance is 1 GΩ or less, and is characterized in that the entire display unit and operating input portion are located within a space that is defined by the main housing unit and the shade.

It is also possible for the endoscope of the present invention having a protruding portion that sandwiches the display unit and the operating input portion between itself and the shade, and that protrudes from the one surface towards the same side as the side towards which the shade protrudes from the one surface.

It is preferable for the protruding portion to have a housing portion in which is housed a portion of an internal structural object that is housed within the main housing unit.

It is also preferable for the shade to be formed from an elastic resin that absorbs the impact generated when the endoscope is dropped.

It is also preferable for the protruding portion to be formed from an elastic resin that absorbs the impact generated when the endoscope is dropped.

When the potential energy of the endoscope if the endoscope is dropped onto the ground from a height that exceeds a predetermined height from the ground at which it is presumed that the endoscope will be used is applied to the shade, or when the kinetic energy if the endoscope strikes the ground from a height that exceeds the predetermined height is applied to the shade, then it is also preferable for the display unit or the operating input portion to come into contact with the ground, and for the shade to vibrate when the endoscope strikes the ground, and for the energy that is imparted to the endoscope when the endoscope strikes the ground to be converted into kinetic energy by the vibrating of the shade.

It is also preferable for the shade to be provided with: a shade main body that shades the display unit; and vibrating portions that are provided on the shade main body and vibrate when the endoscope is dropped, and for the vibrating portions of the shade to vibrate when the endoscope strikes the ground, and for the energy that is imparted to the endoscope to be converted into kinetic energy by the vibrating of the vibrating portions.

### BRIEF DESCRIPTION OF THE DRAWINGS

FIG. 1 is a perspective view showing an endoscope according to an embodiment of the present invention.

FIG. 2 is a side view of the endoscope.

FIG. 3 is a side cross-sectional view of the endoscope.

FIG. 4 is an explanatory view illustrating an action of the endoscope.

FIG. 5 is a partial cross-sectional view showing the structure of a modified example of the endoscope.

FIG. 6 is a partial cross-sectional view showing the structure of another modified example of the endoscope.

FIG. 7 is a side view showing the structure of yet another modified example of the endoscope.

FIG. 8 is a perspective view showing the structure of a portion of an endoscope of the same modified example.

FIG. 9 is a perspective view showing the structure of yet another modified example of the endoscope.

FIG. 10 is a perspective view showing another structural example of the same modified example.

### DETAILED DESCRIPTION OF THE INVENTION

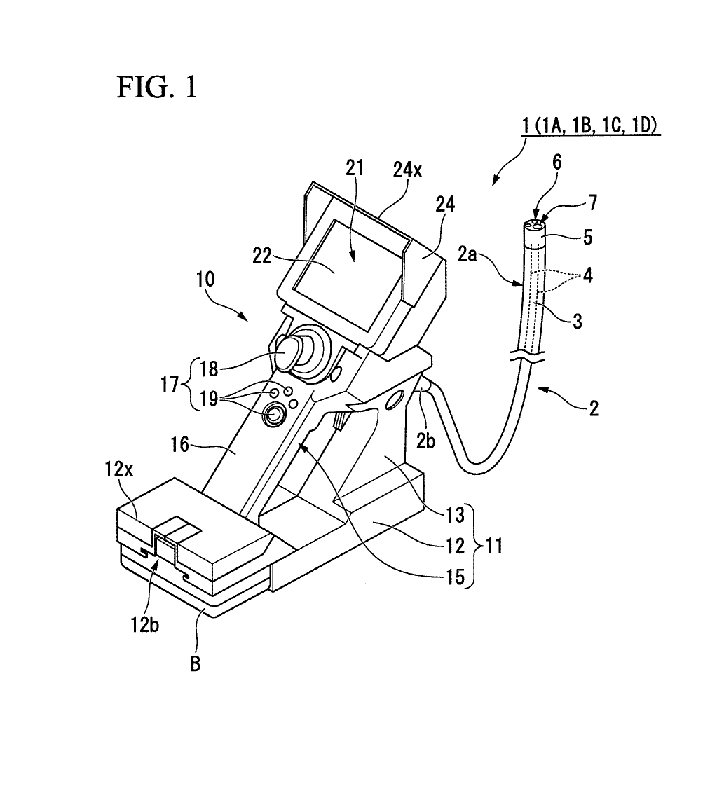

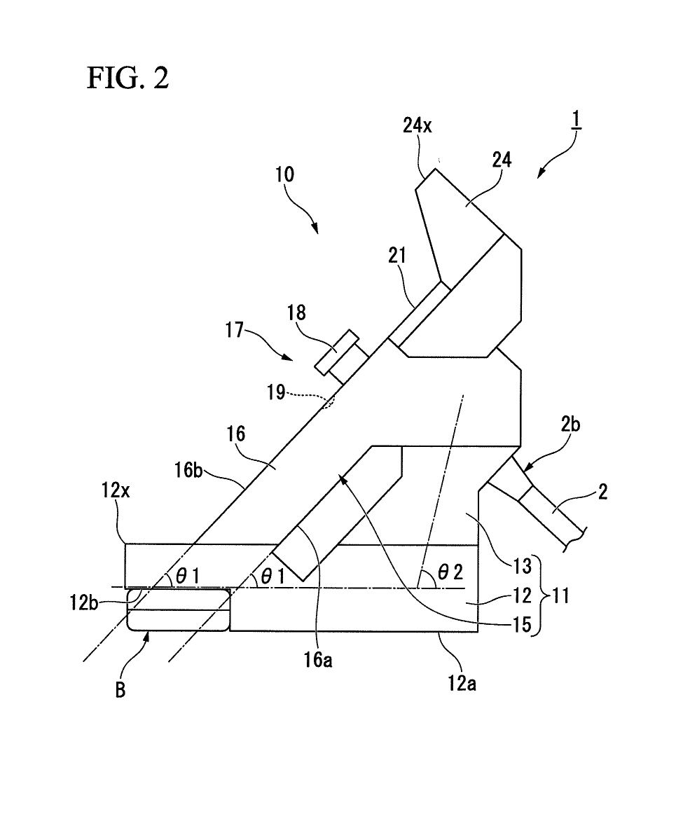

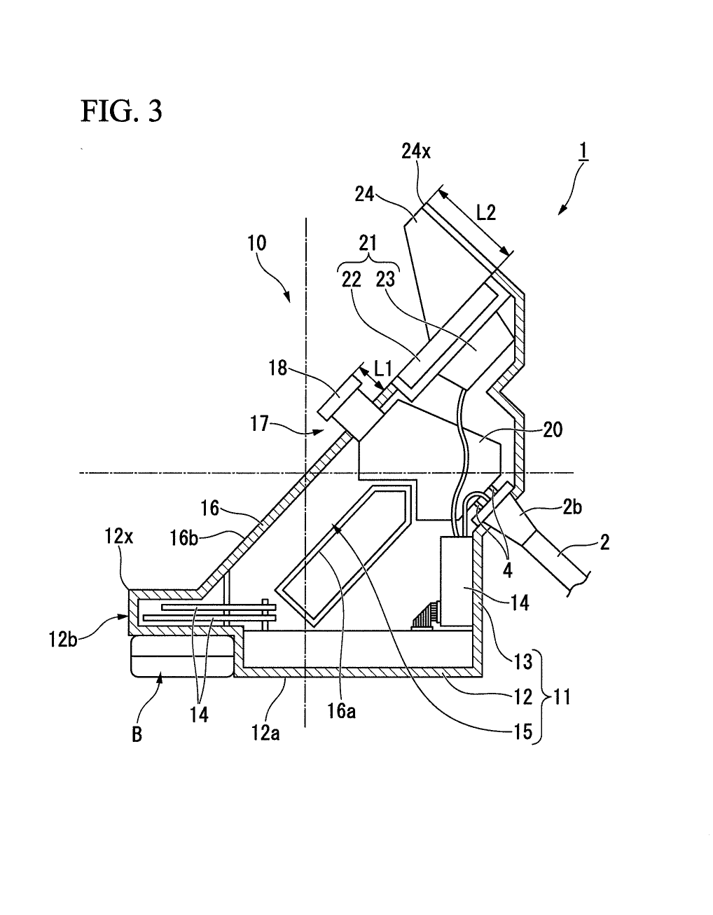

An endoscope 1 according to an embodiment of the present invention will now be described. FIG. 1 is a perspective view showing the endoscope 1 of the present embodiment. FIG. 2 is a side view of the endoscope 1. FIG. 3 is a side cross-sectional view of the endoscope 1.

The endoscope 1 is a device that is used to observe locations that are difficult for an observer to view directly such as the interior of an observation subject and the like. As is shown in FIG. 1, the endoscope 1 is provided with an elongated insertion portion 2 that is inserted from its distal end 2a into the interior of an observation subject, and with a main unit 10 to which a proximal end 2b of the insertion portion 2 is fixed.

The endoscope 1 of the present embodiment has a structure in which at least the main unit 10 has an intrinsically safe explosion-proof structure as stipulated by the IEC (International Electrotechnical Commission). A drop test is defined as one of the requirements of the intrinsically safe explosion-proof structure defined by the IEC. This drop test is a test in which the device is oriented such that the weakest portion thereof faces downwards and the device is then dropped from a predetermined height onto a concrete ground surface G. In the drop test, after the device has been dropped onto the concrete ground surface G, it is deemed to have passed the test if the integrity of a protective structure specified as IP20 by the IEC is maintained.

Moreover, in order to satisfy the intrinsically safe explosion-proof structure requirements, of the components that are exposed on the external surface of the endoscope 1, the surface resistance of those components whose exposed surface area exceeds 400 mm² is 1 GΩ or less. In the present embodiment, of the external surface of the insertion portion 2 and the external surface of the main unit 10, the surface resistance of those components whose exposed surface area exceeds 400 mm² is 1 GΩ or less and the structure is one that makes it difficult for static electricity to accumulate.

The insertion portion 2 is a flexible, cylindrical component. A bending portion 3 that performs a bending operation is provided on the distal end 2a portion of the insertion portion 2. An operating input portion 17 that is used to cause the bending portion 3 to perform a bending operation (described below in more detail) is provided in the main unit 10. In addition, angle wires 4 that are used to cause the bending portion 3 to perform a bending operation are provided inside the insertion portion 2.

An optical adaptor 5 that is able to be removably attached to the insertion portion 2 is also provided at the distal end 2a of the insertion portion 2.

An illumination portion 6 that irradiates illumination light onto an observation subject, and an image acquisition portion 7 that acquires images of the observation subject onto which the illumination light has been irradiated are provided in the optical adaptor 5. The illumination portion 6 irradiates the illumination light onto the observation subject using, for example, a light-emitting diode (LED) or a laser diode (LD) or the like as a light source. The image acquisition portion 7 has an area image sensor such as a CCD or CMOS or the like, and acquires images of the observation subject that it then transmits these images to the main unit 10.

As is shown in FIG. 1 and FIG. 2, the main unit 10 is provided with a main housing unit 11, a display unit 21, an operating input portion 17, and a shade 24.

The main housing unit 11 has a substantially plate-shaped base portion 12, a gripping operating portion 15 that has a first angle θ1 relative to the base portion 12, and a rear surface portion 13 that has a second angle θ2 relative to the base portion 12. The first angle θ1 is smaller than the second angle θ2, and the main housing unit 11 has a substantially triangular external configuration when viewed from a side thereof. As is shown in FIG. 3, a circuit substrate 14 and wiring and the like are housed within the respective interiors of the base portion 12, the gripping operating portion 15, and the rear surface portion 13.

The base portion 12 has a battery mounting portion 12b that is used to mount a battery B, and a bottom surface 12a thereof is formed as a flat surface. Moreover, when the battery B is mounted on the base portion 12, the bottom surface 12a of the base portion 12 and the battery B are substantially flush with each other. As a result, the endoscope 1 can be placed on the ground or the like using the bottom surface 12a of the base portion 12 as the placement surface.

In the present embodiment, the display unit 21 and the operating input portion 17 are sandwiched between the battery mounting portion 12b and the shade 24, and the battery mounting portion 12b is located opposite to the shade 24. The battery mounting portion 12b is formed as a protruding portion that protrudes towards the outside of the main housing unit 11.

As is shown in FIG. 3, the interior of the battery mounting portion 12b is formed as a hollow structure, and functions as a housing portion in which a portion of the internal structural elements of the endoscope 1 are housed. In the present embodiment, a portion of the circuit substrate 14 is housed within the battery mounting portion 12b. A gap is provided between an internal surface of the battery mounting portion 12b and an external surface of the circuit substrate 14 so that, for example, even if an external force is applied to the battery mounting portion 12b resulting in the battery mounting portion 12b being deformed, the internal surface of the battery mounting portion 12b does not come into contact with the circuit substrate 14.

The gripping operating portion 15 has a rod-shaped gripping portion 16 that is gripped by an observer who is using the endoscope 1, and also has the aforementioned operating input portion 17 and display unit 21. The gripping portion 16 is shaped such that an observer is able to grip the gripping portion 16 by placing four of their fingers (excluding the thumb) on a surface of the gripping portion 16 that faces towards the base portion 12 side (i.e., the surface indicated by the symbol 16a in FIG. 2 and FIG. 3, hereinafter, referred to as a bottom surface 16a of the gripping portion 16), and placing their thumb on a surface of the gripping portion 16 that is on the opposite side from the bottom surface 16a (i.e., the surface indicated by the symbol 16b in FIG. 2 and FIG. 3, hereinafter, referred to as a top surface 16b of the gripping portion 16).

The bottom surface 16a and the top surface 16b of the gripping portion 16 are both inclined at the first angle θ1 relative to the base portion 12.

The operating input section 17, the display unit 21, and the shade 24 are each placed on a surface that is substantially on the same plane as the top surface 16b of the gripping portion 16 out of the external surfaces of the gripping operating portion 15. The operating input portion 17 and the display unit 21 are arranged next to each other at one end in the longitudinal direction of the gripping portion 16. The operating input portion 17 is placed closer to the gripping portion 16 than is the display unit 21.

The operating input portion 17 is provided at the main unit 10 in order to enable an observer to input operations into the endoscope 1, and has, for example, an operating lever 18 that is used to cause the bending portion 3 to perform a bending operation, and a push button 19 such as a freeze button or the like that is used to acquire a still image of an observation subject.

The operating lever 18 has a support point inside the gripping operating portion 15, and protrudes in a direction that intersects the top surface 16b of the gripping portion 16. As is shown in FIG. 3, a pulling mechanism 20 that pulls the angle wires 4 is connected to the operating lever 18. The pulling mechanism 20 employs a mechanism that, for example, pulls the angle wires using power from a servo motor or the like, or employs a mechanism that, for example, mechanically pulls the angle wires 4 using the operating power of the operating lever 18 via a link mechanism or pulleys or the like.

As a result of the operating lever 18 being tilted from a neutral position, the bending portion 3 (see FIG. 1) is bent in a predetermined direction that corresponds to the direction in which the operating lever 18 has been tilted. Note that it is also possible to employ a structure in which, when the observer releases their fingers from the operating lever 18 after having tilted it from a neutral position, the operating lever 18 is returned to the neutral position by restorative force.

An observer is able to press their thumb against a protruding end of the operating lever 18, and can use their thumb to operate the operating lever 18 while gripping the gripping portion 16 with their hand. Note that it is also possible for pits or bumps that function as an anti-slippage device to be formed on the protruding end of the operating lever 18.

The display unit 21 has a display panel 22 such as a liquid crystal display or an organic EL display that is exposed on the external surface of the gripping operating portion 15, and a control circuit 23 that is provided inside the gripping operating portion 15 and controls the display panel 22. Note that it is also possible for the control circuit 23 of the display panel 22 to be provided inside the rear surface portion 13 or base portion 12. The display unit 21 displays images of an observation subject on the display panel 22. As a result, an observer who is using the endoscope 1 is able to view images of the observation subject using the display unit 21. The display unit 21 is provided together with the operating input section 17 on one of the external surfaces (i.e., near the top surface 16b of the gripping portion 16 in the present embodiment) of the gripping operating portion 15. As a result, the operator is able to view images displayed on the display unit 21 while operating the operating lever 18 and push button 19 of the operating input portion 17.

It is preferable for the display panel 22 to have as wide a display screen as possible as long as it does not hinder the portability of the endoscope 1. However, if the area of the display screen of the display panel 22 exceeds 400 mm², then it falls into the category of screens whose surface resistance upper limit is limited in accordance with explosion-proof standards. In the present embodiment, a display panel 22 having a rectangular display screen whose area exceeds 400 mm² is employed, and either an anti-static film is laminated onto the display screen of the display panel 22 or surface processing to prevent static electricity is performed on the display screen of the display panel 22. By doing this, the surface resistance of the display panel 22 is limited to 1 GΩ or less.

In the present embodiment, by performing processing or implementing measures in order to limit the surface resistance of the display panel 22 to 1 GΩ or less, the display panel 22 satisfies the requirements demanded of an intrinsically safe explosion-proof structure. There may also be cases in which the AG (antiglare) processing or the AR (antireflection) processing that is performed in order to prevent outside light or other objects being reflected in the display screen of the display panel 22 is insufficient. Because of this, if the endoscope 1 is used under strong illumination or in sunlight, then the possibility should be considered that images displayed on the display panel 22 will become difficult to see due to the external light directly striking the display screen of the display panel 22.

In order to make images displayed on the display screen of the panel 22 of the display unit 21 easy to see even under strong illumination or in sunlight, the sun-blocking shade 24 is mounted on the gripping operating portion 15 so as to surround a portion of the periphery of the display panel 22.

The shade 24 is placed around three of the four sides of the display panel 22 except for the side that is located closest to the operating input portion 17. The shade 24 is formed substantially in a U shape when viewed from a direction that is perpendicular to the top screen 16b of the gripping portion 16, and is fixed to the gripping operating portion 15.

The shade 24 protrudes from an external surface of the gripping operating portion 15 in a direction that intersects the surface of the display panel 22. The direction in which the shade 24 protrudes from the gripping operating portion 15 is substantially the same as the direction in which the operating lever 18 protrudes from the gripping operating portion 15. As is shown in FIG. 3, when measured in a perpendicular direction relative to the top surface 16b of the gripping portion 16, a length L2 that the shade 24 protrudes is longer than a length L1 that the operating lever 18 protrudes. The shade 24 is formed from a flexible resin having a surface resistance of 1 GΩ or less. The shade 24 also has elasticity so that if, for example, the endoscope 1 is dropped so that the shade 24 strikes the ground G, then even if this causes the shade 24 to be deformed, it is restored to its original shape by its own restorative force.

The shade 24 has sufficient resilience that, if the potential energy of the endoscope 1 if the endoscope 1 is dropped onto the ground G from a height that exceeds a predetermined height from the ground G at which it is presumed that the endoscope 1 will be used is applied to the endoscope 1, or if the kinetic energy if the endoscope 1 strikes the ground G from a height that exceeds the predetermined height is applied to the shade 24, then the display unit 21 or the operating input portion 17 will come into contact with the ground G Note that the aforementioned predetermined height may be determined, for example, based on a height determined in a drop test that is performed in order to satisfy the requirements of an intrinsically safe explosion-proof construction that are sought in the endoscope 1.

The flexibility of the shade 24 can be set to the optimum flexibility by appropriately selecting the material, thickness and shape of the shade 24. For example, if ribs that reinforce the shade 24 are formed in the shade 24, the flexibility of the shade 24 is reduced compared with when such ribs are not provided. Moreover, the greater the thickness of the shade 24, the more the flexibility of the shade 24 is reduced.

As is shown in FIG. 2, the entire display unit 21 and operating input portion 17 are placed inside a space that is defined by the main housing unit 11 and the shade 24. As a result, if the endoscope 1 is placed on the ground G such that both the shade 24 and the base portion 12 are in contact with the ground G, the positions of the display unit 21 and the operating input portion 17 are away from the ground G In the present embodiment, because a protruding end 12x of the battery mounting portion 12b that is provided in the base portion 12 and a protruding end 24x of the shade 24 both protrude from the top surface 16b of the gripping portion 16, the space that is defined by the main housing unit 11 and the shade 24 has a square shape profile when seen in side view.

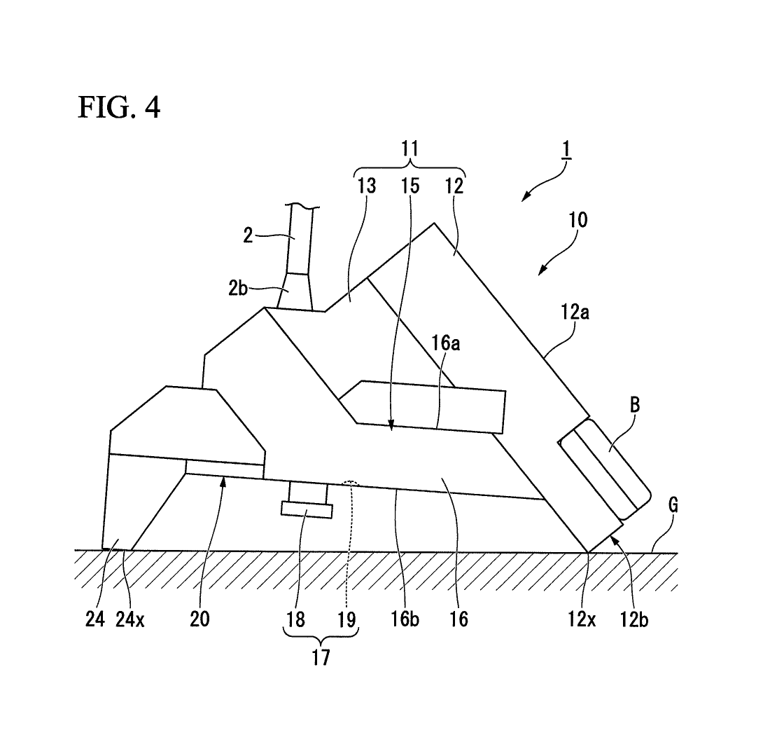

An action of the endoscope 1 having the above-described structure will now be described. FIG. 4 is an explanatory view illustrating an action of the endoscope 1.

When the endoscope 1 is put to use, an observer holds the gripping portion 16 in one hand and, for example, holding the insertion portion 2 in the other hand guides the image acquisition portion 7 to the observation subject.

At this time, the observer operates the operating lever 18 and the push-button 19 and the like that are provided in the operating input portion 17 while viewing images displayed on the display panel 22 of the display unit 21 that is provided in the main unit 10.

Because the endoscope 1 of the present embodiment is able to be carried around by the observer, it is quite possible that, for example, the observer may accidentally drop the endoscope 1, or that the endoscope 1 may fall after being placed in an unstable location.

If the endoscope 1 does fall, then it strikes the ground G or the like. At this time, it is difficult to predict which part of the external surface of the endoscope 1 will strike the ground G, and there are also cases in which, for example, the external surface on the side where the operating input portion 17 or the display unit 21 are located will be facing towards the ground G or the like.

In order to satisfy the requirements of an intrinsically safe explosion-proof construction as prescribed by the IEC, when, in the drop test, the device is oriented such that the weakest portion thereof faces downwards and the device is then dropped from a predetermined height onto a concrete ground surface G, it is necessary for the integrity of a protective structure specified as IP20 to be maintained. In the endoscope 1 of the present embodiment, the weakest portion of the device is the surface where the operating input portion 17 and the display unit 21 are provided (i.e., the surface that extends along the top surface 16b of the gripping portion 16).

As is shown in FIG. 4, if, for example, the endoscope 1 is dropped onto the ground G while the top surface 16b of the gripping portion 16 is facing downwards, then the protruding end 24x of the shade 24 and the protruding end 12x of the battery mounting portion 12b both strike the ground G. At this time, the operating input portion 17 in the display unit 21 are also facing downwards, however, the display unit 21 and the operating input portion 17 that are located inside the space defined by the shade 24 and the external surfaces of the main unit 10 are protected so that they do not come into contact with the ground G.

Furthermore, because the shade 24 has elasticity, a portion of the shock imparted to the endoscope 1 from the ground G is absorbed as a result of the shade 24 being deformed. Consequently, the possibility that the electronic components such as the circuit substrate 14 that are located inside the main unit 10 of the endoscope 1 and the display panel 22 and the like will be damaged is kept to a low level.

Moreover, because the shade 24 has flexibility, when the endoscope 1 strikes the ground G, the shade 24 vibrates because of the energy that is transmitted thereto. Namely, a portion of the energy transmitted to the shade 24 is converted into kinetic energy that causes the shade 24 to vibrate.

Furthermore, because the shade 24 has elasticity, even if the shade 24 strikes the ground G and is deformed, the shade 24 is restored to its original shape.

As has been described above, according to the endoscope 1 of the present embodiment, even if the endoscope 1 is dropped with the operating input portion 17 in the display portion 21 facing downwards, the possibility that the operating input portion 17 and the display unit 21 will come into contact with the ground G is kept extremely low. As a result of this, it is possible to prevent the operating input portion 17 and the display unit 21 from being damaged if the endoscope 1 is dropped.

Moreover, the endoscope 1 of the present embodiment has a structure in which the operating input portion 17 and the display unit 21 are both located on a surface that extends along the top surface 16b of the gripping portion 16, and components that might be easily broken if the endoscope 1 were to be dropped are consolidated in a portion of the main housing unit 11. Because of this, it is possible to collectively protect all of the easily broken components using the shade 24, and it is therefore possible to protect the endoscope 1 from an impact without increasing the number of components making up the endoscope 1.

Moreover, because the shade 24 which blocks the sunlight to the display unit 21 also functions as a component that protects the display unit 21 and the operating input portion 17 from an impact, it is not necessary to provide a dedicated guard or the like in order to protect the display unit 21 and the operating input portion 17 from an impact, and it is thereby possible to not only decrease the number of components, but to also reduce the size and weight of the endoscope 1.

### MODIFIED EXAMPLE 1

Next, a modified example of the above-described endoscope 1 will be described. Note that in the respective modified examples described below, component elements that are the same as the component elements in the above-described endoscope 1 are given the same descriptive symbols and any duplicated description thereof is omitted.

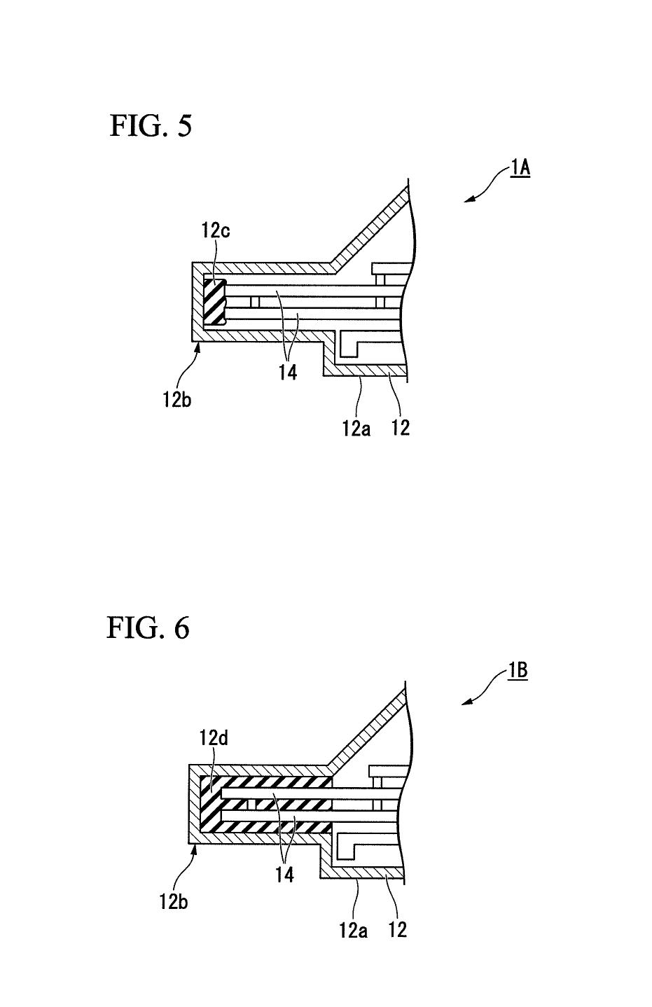

FIG. 5 is a cross-sectional view showing a portion of the structure of an endoscope 1A of the present modified example.

As is shown in FIG. 5, in the endoscope 1A of the present modified example, an elastic supporting body 12c that supports the circuit substrate 14 is provided inside the battery mounting portion 12b.

The elastic supporting body 12c is positioned so as to be sandwiched between the internal surface of the battery mounting portion 12b and the external surface of the circuit substrate 14, and supports the circuit substrate 14 such that the circuit substrate 14 does not come into contact with the internal surface of the battery mounting portion 12b. In addition, the elastic supporting body 12c also absorbs a portion of the impact when the battery mounting portion 12b strikes the ground G or the like so as to alleviate the impact on the circuit substrate 14.

By providing the elastic supporting body 12c it is possible to decrease the likelihood of the circuit substrate 14 being damaged when the endoscope 1A is dropped onto the ground G.

### MODIFIED EXAMPLE 2

Next, another modified example of the above-described endoscope 1 will be described. FIG. 6 is a cross-sectional view showing a portion of the structure of an endoscope 1B of the present modified example.

As is shown in FIG. 6, in the endoscope 1B of the present modified example, the interior of the battery mounting portion 12b is filled with an elastic resin 12d. The elastic resin 12d that is used to fill the interior of the battery mounting portion 12b is placed so as to fill the gap between the circuit substrate 14 and the internal surface of the battery mounting portion 12b.

In this type of structure is well, in the same way as in the above-described modified example 1, it is possible to reduce the likelihood of the circuit substrate 14 being damaged.

### MODIFIED EXAMPLE 3

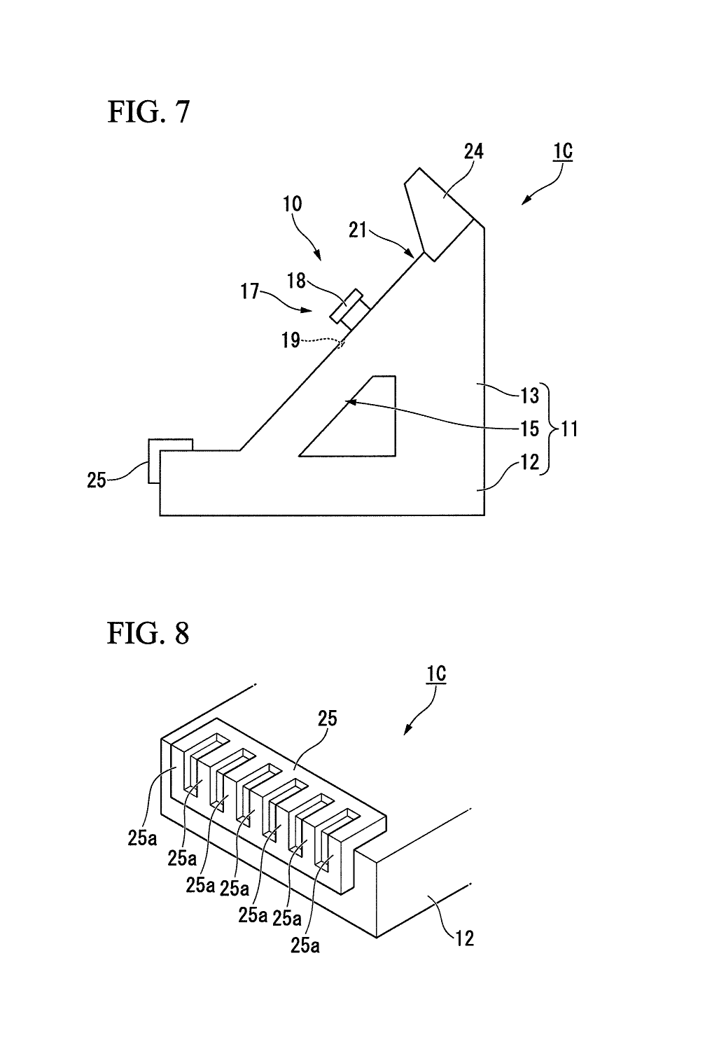

Next, yet another modified example of the above-described endoscope 1 will be described. FIG. 7 is a side view showing the structure of an endoscope 1C of the present modified example. FIG. 8 is a perspective view showing the structure of a portion of the endoscope 1C.

As is shown in FIG. 7 and FIG. 8, the endoscope 1C of the present modified example differs in that a damper component 25 that absorbs the impact when the endoscope 1C is dropped is provided in a portion of the external surface of the battery mounting portion 12b.

The damper component 25 is formed from an elastic resin. The damper component 25 comes into contact with the ground G or the like (see FIG. 4) when, for example, the endoscope 1C is dropped so as to become elastically deformed. Thereafter, the damper component 25 is returned to its original shape by its own restorative force. The damper component 25 has a plurality of fins 25a (vibrating portions) that are positioned with gaps provided between them.

The fins 25a are shaped such that they are made to vibrate by the energy generated when the damper component 25 strikes the ground G Namely, if the endoscope 1C is dropped, the energy from the impact that is transmitted to the endoscope 1C from the ground G is converted into kinetic energy in each fin 25a.

In the endoscope 1C, it is sufficient for the damper component 25 to protrude from the top surface 16b of the gripping portion 16, and it is not essential for the battery mounting portion 12b to also protrude from the top surface 16b of the gripping portion 16. Namely, in the present modified example, the damper component 25 corresponds to the protruding portion of the present invention.

Moreover, in the same way as in the above-described endoscope 1, the endoscope 1C makes it possible for any damage to the operating input portion 17 and the display unit 21 to be prevented if the endoscope 1C is dropped.

Furthermore, in the present modified example, because any impact is absorbed not only by the shade 24, but by the damper component 25 as well, it is possible to limit even further the possibility of the endoscope IC being damaged by the impact from the ground G on the endoscope 1C.

### MODIFIED EXAMPLE 4

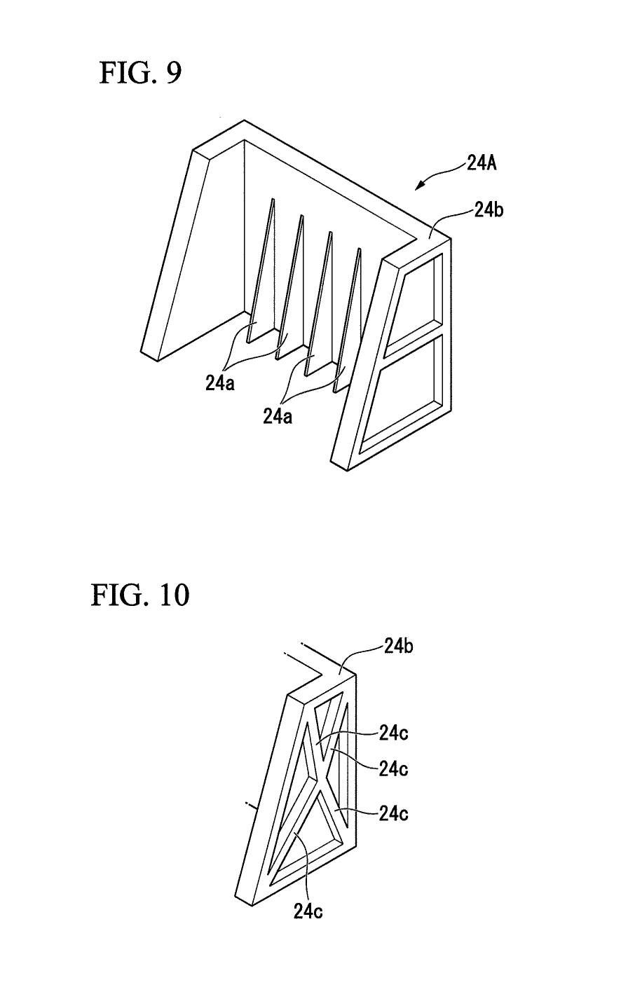

Next, yet another modified example of the above-described endoscope 1 will be described. FIG. 9 and FIG. 10 are perspective views showing the structure of an endoscope 1D of the present modified example.

As is shown in FIG. 9, the endoscope 1D of the present modified example (see FIG. 1) is provided with a shade 24A having a different shape from that of the shade 24 that is provided in the endoscope 1, instead of the shade 24.

The shade 24A is provided with a shade main body 24b that shades the sunlight to the display unit 21, and with vibrating portions (i.e., fins 24a) that are provided on the shade main body 24b and vibrate if the endoscope 1D is dropped.

The shade main body 24b vibrates when the endoscope 1D is dropped in the same way as the above-described shade 24. Furthermore, the vibrating portions are constructed such that they vibrate more easily than the shade main body 24b. In the present modified example, the vibrating portions are formed by fins 24a that are formed thinner than the shade main body 24b.

The fins 24a protrude from the external surface of the shade main body 24b, and a plurality of these fins 24a are formed with gaps provided between each of them. The fins 24a are more easily vibrated by a weaker impact than the shade main body 24b. If the endoscope 1D is dropped, the energy of the impact that is transmitted to the endoscope 1D from the ground G is converted into kinetic energy in each of the fins 24a.

Note that, in addition to the fins 24a being formed on the shade 24, as is shown in FIG. 9, it is also possible for a portion of the shade main body 24b, other than diagonally intersecting beam portions 24c, to be formed extremely thinly, as is shown in FIG. 10. In this case, the thin portions vibrate in the same way as the fins 24a.

While preferred embodiments of the invention as well as modified examples thereof have been described in detail above with reference made to the drawings, it should be understood that these are exemplary of the invention and are not to be considered as limiting. Additions, omissions, substitutions, and other modifications can be made without departing from the spirit or scope of the present invention.

For example, the structural elements illustrated in the above-described embodiments and modified examples thereof may also be combined into various suitable combinations.

In addition, the invention is not to be considered as limited by the foregoing description and is only limited by the scope of the appended claims.

What is claimed is:

1. An endoscope comprising:
a main housing unit that is formed from a material having a surface resistance of 1 GΩ or less;
a display unit that is mounted on one surface of the external surfaces of the main housing unit and displays images of an observation subject;
an operating input portion that is mounted on the one surface of the main housing unit; and
a sun-blocking shade that is fixed to the one surface of the main housing unit and protrudes from the one surface in a direction that intersects the one surface so as to surround a portion of the periphery of the display unit, and that is formed from a flexible resin whose surface resistance is 1 GΩ or less, wherein
the entire display unit and operating input portion are located within a space that is defined by the main housing unit and the shade.

2. The endoscope according to claim 1, further comprising
a protruding portion that sandwiches the display unit and the operating input portion between itself and the shade, and that protrudes from the one surface towards the same side as the side towards which the shade protrudes from the one surface.

3. The endoscope according to claim 2, wherein the protruding portion has a housing portion in which is housed a portion of an internal structural object that is housed within the main housing unit.

4. The endoscope according to claim 1, wherein the shade is formed from an elastic resin that absorbs the impact generated when the endoscope is dropped.

5. The endoscope according to claim 2, wherein the protruding portion is formed from an elastic resin that absorbs the impact generated when the endoscope is dropped.

6. The endoscope according to claim 1, wherein,
when the potential energy of the endoscope if the endoscope is dropped onto the ground from a height that exceeds a predetermined height from the ground at which it is presumed that the endoscope will be used is applied to the shade, or when the kinetic energy if the endoscope strikes the ground from a height that exceeds the predetermined height is applied to the shade, then the display unit or the operating input portion come into contact with the ground, and
the shade vibrates when the endoscope strikes the ground, and the energy that is imparted to the endoscope when the endoscope strikes the ground is converted into kinetic energy by the vibrating of the shade.

7. The endoscope according to claim 6, wherein
the shade comprises:
a shade main body that shades the display unit; and
vibrating portions that are provided on the shade main body and vibrate when the endoscope is dropped, and wherein
the vibrating portions of the shade vibrate when the endoscope strikes the ground, and the energy that is imparted to the endoscope is converted into kinetic energy by the vibrating of the vibrating portions.
